(19) United States
(12) Patent Application Publication
(10) Pub. No.: US 2020/0374579 A1
(43) Pub. Date: Nov. 26, 2020

(54) AUDIO SYSTEM FOR VEHICLE

(71) Applicant: Visteon Global Technologies, Inc., Van Buren Township, MI (US)

(72) Inventors: Yao H. Kuo, West Bloomfield, MI (US); Michael Heinrich Zahm, Waldbronn (DE); James E. Brewer, Plymouth, MI (US); Christopher John Barranger, Whitmore Lake, MI (US)

(21) Appl. No.: 16/417,903

(22) Filed: May 21, 2019

(51) Int. Cl. H04N 21/414; H04L 29/06; G06F 3/16; H04W 76/15

(52) U.S. Cl. CPC H04N 21/41422; H04L 65/608; H04W 76/15; G06F 3/162; H04L 65/4076

(57) ABSTRACT

An audio system may receive a media stream, via a first wireless connection, in an analog format. The audio system may digitize the media stream, as received via the first wireless connection, to provide a first sub-stream. The audio system may receive a media stream, via a second wireless connection, in a digital format. The media stream from the second wireless connection may be a second sub-stream. The audio system may compare at least one reproduction characteristic of the first sub-stream and the second sub-stream. The audio system may adjust at least one further reproduction characteristic of the second sub-stream based on the comparison.

### FIELD

This disclosure relates to systems and methods for vehicle audio systems, and in particular, to systems and methods for vehicle audio systems that receive multiple streams of audio, which may be in digital or analog formats.

### RELATED ART

There are several established digital radio broadcast systems, such as In Band On Channel (IBOC), Digital Radio Mondiale (DRM), Digital Audio Broadcast (DAB). Some of these digital broadcasts transmit the same program in both digital and analog signals simultaneously in-band-on-channel, or in separated bands, such as in the case of DAB and frequency modulation (FM). Whenever either type of broadcast is received with better or worse performance than the other type of broadcast, the radio switches to receive the better type of broadcast signal by preferred control algorithm. The better or worse performance may be characterized in terms of an available reproduction bandwidth, distortion, or signal to noise ratio. However, between a digital broadcast signal and an analog broadcast signal, for example, there may be time delay differences, amplitude differences, stereo separation differences, and audio response differences. These differences may cause an abrupt change in the sound field. A listener may readily perceive such abrupt changes and consider them undesirable.

### SUMMARY

This disclosure relates generally to systems and methods for vehicle audio systems.

An aspect of the disclosed embodiments is an audio system that includes a tuner configured to receive a broadcast signal and a controller coupled to the tuner. The controller may be configured to condition the broadcast signal for an analog path and a digital path. The controller may also be configured to compare a reproduction characteristic of the broadcast signal from the analog path to a reproduction characteristic of the broadcast signal from the digital path. The controller may further be configured to adjust, based on the comparison, a further reproduction characteristic of the broadcast signal from the digital path.

Another aspect of the disclosed embodiments is an audio system that includes a tuner configured to receive a broadcast signal. The audio system may also include a controller coupled to the tuner. The controller may be configured to condition the broadcast signal for an analog path and a digital path. The controller may also be configured to compare a reproduction characteristic of the broadcast signal from the analog path to a reproduction characteristic of the broadcast signal from the digital path. The controller may further be configured to adjust, based on the comparison, a further reproduction characteristic of the broadcast signal from the analog path.

Another aspect of the disclosure embodiments is a non-transitory computer-readable storage medium that includes instructions that, when executed by a processor, cause the processor to output a sub-stream in an audio system, by performing a process. The process may include receiving, at a device, a media stream via a first wireless connection in an analog format. The process may also include digitizing the media stream as received via the first wireless connection to provide a first sub-stream. The process may further include receiving, at the device, the media stream via a second wireless connection in a digital format as a second sub-stream. The process may additionally include comparing, at the device, at least one reproduction characteristic of the first sub-stream and the second sub-stream. The process may also include adjusting, based on the comparison, at least one further reproduction characteristic of either the first sub-stream or the second sub-stream.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a system according to the principles of the present disclosure.

FIG. 2 generally illustrates a system according to the principles of the present disclosure.

FIG. 3 generally illustrates a method of audio bandwidth control, according to the principles of the present disclosure.

FIG. 4 generally illustrates signal changes over time during a switch from an analog path to a digital path, according to the principles of the present disclosure.

FIG. 5 generally illustrates switching between data streams according to the principles of the present disclosure.

FIG. 6 generally illustrates variations on audio bandwidth, according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As mentioned above, a radio may switch between analog and digital reception techniques, or more generally between any two reception streams. Furthermore, between digital broadcast signal and analog broadcast signal there may be time delay differences, amplitude differences, stereo separation differences, and audio response differences.

Any difference between the two reception streams may cause an abrupt change in the reception sound field. This abrupt change may degrade reception performance and frustrate drivers or other listeners of a car radio system.

For radio listeners to have a smooth experience, the sound field may smoothly transition. One aspect of this experience is the audio bandwidth. Audio bandwidth may affect the listener perception of the radio stream. Without certain embodiments, differences in audio bandwidth between the streams may be noticeable when the radio switches between digital broadcasted signal and analog broadcasted signal under various signal conditions.

One or more embodiments are distinct from using individual dynamic audio bandwidth control for each path for normal reception purposes. Instead, one or more embodiments may match or track the audio bandwidth or other audio characteristics between two audio streams, to permit switching between reception paths with minimal noticeable difference between the streams.

Thus, one or more embodiments relate to switching control methods to achieve a smooth transition when a radio switches between digital broadcasting (having a first maximum audio bandwidth) and analog broadcasting (having a second maximum audio bandwidth), whether from digital to analog or from analog to digital.

A system according to one or more embodiments may continuously monitor a valid data rate and signal to noise ratio (SNR) from digital broadcast signal path and may continuously monitor audio bandwidth and SNR from analog broadcast signal path. The system may dynamically control both paths' audio bandwidths simultaneously.

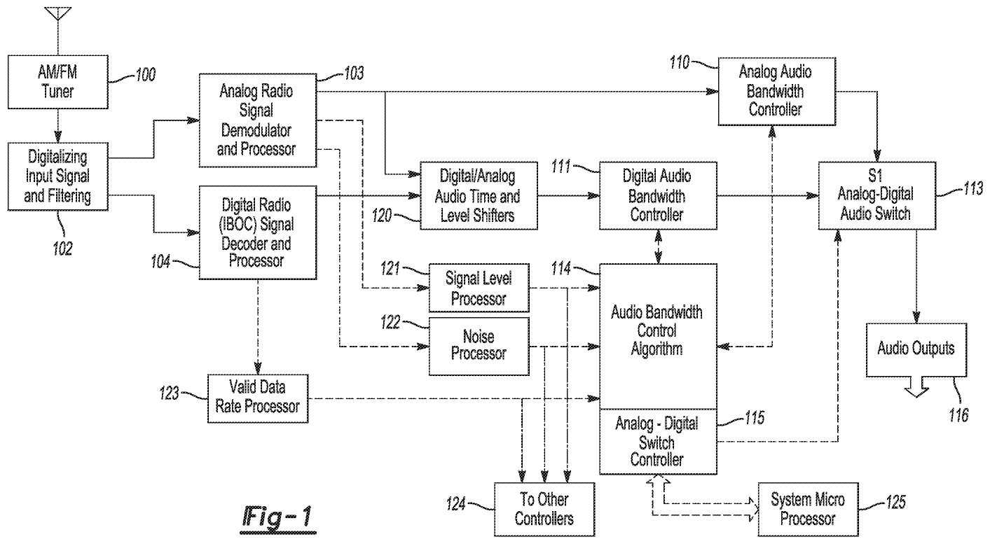

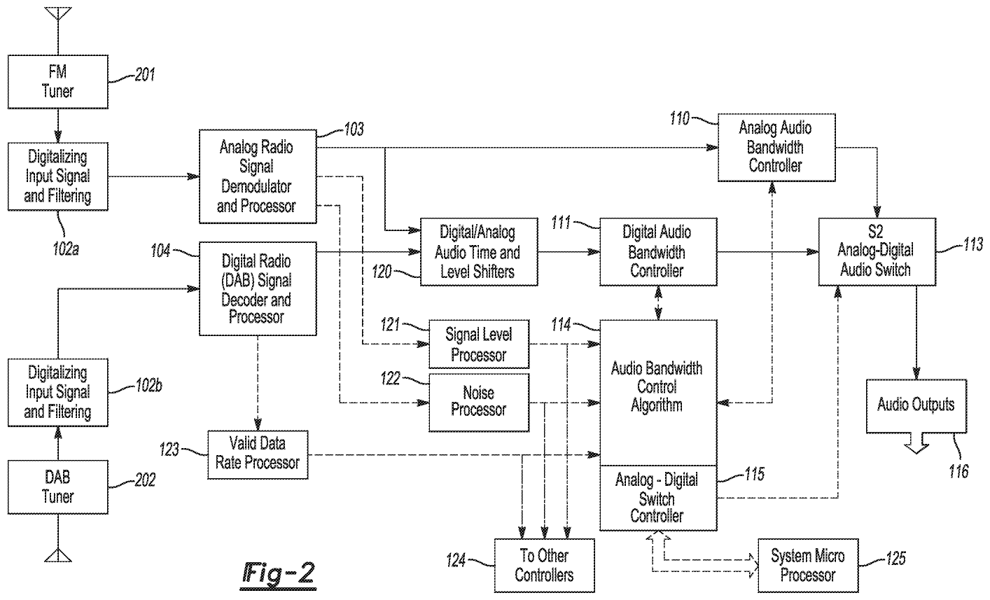

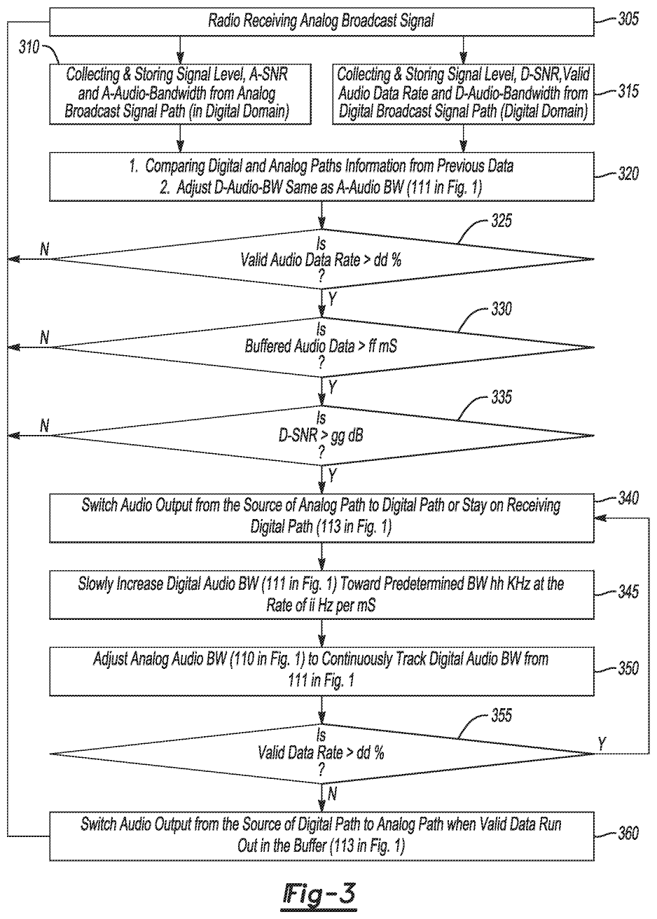

FIG. 1 illustrates a system according to one or more embodiments, which may be applicable to an IBOC radio system. An example of an IBOC radio system is high definition (HD) radio in North America.

As shown in FIG. 1, the system may include an AM/FM tuner 100 with a digitalizing input signal and filtering block 102. These reception blocks may be implemented using any desired tuner and digitizer. These reception blocks may provide input signals to an analog radio signal demodulator and processor 103 as well as to a digital radio signal decoder and processor 104.

FIG. 1 further illustrates an analog audio bandwidth controller 110. This block may be configured to control the bandwidth of an analog audio stream. Likewise, the digital audio bandwidth controller 111 may be configured to control the bandwidth of a digital audio stream.

FIG. 1 also illustrates digital/analog audio time and level shifters 120. This block is shown as though only the digital path is affected, but alternatively this block may be applied to the analog path, or to both paths.

An analog-digital audio switch 113 may receive inputs from the two paths and may select one path as an audio output 116. The analog-digital audio switch 113 may be controlled by analog-digital controller 115, which may be running an audio bandwidth control algorithm 114. An example of the audio bandwidth control algorithm 114 is shown in FIG. 3. The analog-digital controller 115 may be any suitable hardware computer processor, such as a computer chip, central processing units (CPU), core, application specific integrated circuit (ASIC), field programmable gate array (FPGA), or any similar device. More than one processor may be used and different kinds of processors may be used.

The audio output 116 may be a digital line out, which may contain all the original broadcasted audio information/data in digital format(s). The data from audio output 116 may be provided to a device that is expecting an audio data stream. When the audio data stream is ultimately destined for audio processing in a digital signal processor (DSP) such as monophonic, stereophonic, audio tone control or multi-audio-channel signals processors/decoder (all not belong to this subject scope), then the decoded data stream(s) may be fed into one or many digital-to-analog converters (DACs) (or more complex devices). Each output of a given DAC's signal may be sent to audio pre-amplifiers. Power amplifiers may then deliver all audio channels to proper speakers. In one or more embodiments, in place of a digital line out the system may convert the audio stream into a set of analog channels. For example, the system may generate a unique analog output for each speaker of a vehicle. Other approaches are also permitted.

For the analog path, a signal level processor 121 and a noise processor 122 may be used to analyze the audio signal. Other analysis tools are also permitted. The results of such processors may be provided as inputs to the audio bandwidth control algorithm 114. The audio bandwidth control algorithm 114 may provide control signals to, for example, the analog audio bandwidth controller 110.

Analog audio bandwidth controller 110 and digital audio bandwidth controller 111 may be configured as fixed predetermined audio bandwidth filters.

The output of the signal level processor 121, noise processor 122, and valid data rate processor 123, may be provided to other controls 124.

The analog-digital controller 115 may be in communication with a system micro-processor 125. The system micro-processor 125 may be any suitable processor, like the analog-digital controller 115. The system micro-processor 125 and the analog-digital controller 115 may be implemented separately or together. For example, the system micro-processor 125 and the analog-digital controller 115 may be implemented on two different chips, on two different cores of a same chip, or as two different processes or sets of processes on the same chip. Other implementations are also permitted.

Thus, FIG. 1 shows an IBOC radio system. By contrast, FIG. 2 illustrates a system according to one or more embodiments, which may be applicable to DAB and FM radio system.

Thus, there are some differences between the system of FIG. 2 and the system of FIG. 2. For example, in FIG. 2 there may be an FM tuner 201, which may undergo, at 102a, digitalizing input signal and filtering, before being provided to the analog radio signal demodulator and processor 103.

Similarly, in FIG. 2 the system may include a DAB tuner 202, which may undergo, at 102b, digitalizing input signal and filtering, before being provided to the digital radio signal decoder and processor 104. Otherwise, the two systems of FIG. 1 and FIG. 2 may be and operate the same.

FIG. 3 illustrates a method of audio bandwidth control, according to one or more embodiments.

The method of FIG. 3 may begin, at 305, with a radio receiving an analog broadcast signal. As shown by the line on the left side, whenever the process completes, it may return to 305.

The method may include, at 310, collecting and storing signal level, A-SNR, and A-audio-bandwidth from an analog broadcast signal path (in the digital domain). In parallel to 310, at 315 the method may include collecting and storing signal level, D-SNR, valid audio data rate and D-audio-bandwidth from a digital broadcast signal path (in the digital domain).

At 320, two steps may occur: (1) comparing digital and analog paths' information from previous data, and (2) adjusting D-audio-bandwidth to be the same as A-audio-bandwidth (111 in FIG. 1).

Next, at 325, a system performing the method may check whether a valid audio data rate is greater than a threshold percent (dd %). The system may also check, at 330, whether buffered audio data is greater a threshold number of milliseconds (ff mS). Furthermore, at 335, the system performing the method may check whether D-SNR is greater than a threshold number of decibels (gg dB). If any of these thresholds is not met, then the system may return to 305. If all of these thresholds are met, the system may proceed with additional steps of the method. Optionally, in one or more embodiments not all of these thresholds may be used together. Likewise, optionally in one or more embodiments other thresholds may be used together with all or some of these thresholds.

At 340, the method may include switching (using 113 in FIG. 1 for example) audio output from the analog path to the digital path or simply staying on a receiving digital path. The system may also slowly increase digital audio BW (111 in FIG. 1) toward a predetermined BW hh Khz at a rate of ii Hz per mS. The predetermined rate may be set in advance or may be calculated to permit the entire necessary BW adjustment to occur within a predetermined time limit, such as two or three seconds.

At 350, the method may include adjusting the analog audio bandwidth (110 in FIG. 1) to continuously track the digital audio bandwidth (from 111 in FIG. 1). At 355, the system may determine whether the valid audio data rate is greater than a threshold percent (the same dd % used at 325). If so, the system may return to 340. If not, the system may, at 360, switch (using 113 in FIG. 1 for example) the audio output from the digital path to the analog path, when valid data runs out in the buffer.

Various systems may implement the method shown in FIG. 3. For example, the method may be implemented by the system shown in FIG. 1 or FIG. 2. Other arrangements are also possible.

For example, a method according to one or more embodiments may include receiving, at a device, a media stream via a first wireless connection in an analog format. 18. The method of claim 1, wherein the device comprises a car radio receiver.

The method may also include digitizing the media stream as received via the first wireless connection to provide a first sub-stream. The media may be audio, video, or any combination thereof. The receiving may include receiving a wireless signal at an antenna and downconverting the signal. The digitizing may include converting an analog signal into a digital signal, for example by sampling the signal.

The method may further include receiving, at the device, the media stream via a second wireless connection in a digital format as a second sub-stream. The first wireless connection and the second wireless connection may each be broadcast signals. The first wireless connection may be an analog radio signal. The second wireless connection may be a digital radio signal. The first wireless connection and the second wireless connection may be received over the same antenna or different antennas. The reception chains may also include separate receivers and separate tuners.

The method may additionally include comparing, at the device, at least one reproduction characteristic of the first sub-stream and the second sub-stream. The at least one reproduction characteristic may be audio bandwidth. Other characteristics may also be used.

The method may also include adjusting at least one further reproduction characteristic of the second sub-stream based on the comparison. The at least one further reproduction characteristic may be audio bandwidth.

The method may further include switching an output from the first sub-stream to the second sub-stream, or maintaining use of the second sub-stream, based on analyzing a signal characteristic of the second sub-stream. The switching may, for example, be based on a valid audio data rate exceeding a threshold data rate. The switching, for another example, may be based on an amount of buffered audio data exceeding a threshold number of milliseconds. In another example, the switching may be based on a digital signal-to-noise ratio exceeding a threshold number of decibels.

The method may additionally include increasing a digital audio bandwidth toward a predetermined bandwidth at a predetermined rate. The method may also include adjusting analog audio bandwidth to continuously track the digital audio bandwidth.

Furthermore, the method may include switching from the second sub-stream to the first sub-stream based on a buffer status. The buffer status that triggers the switch may be that the buffer is empty.

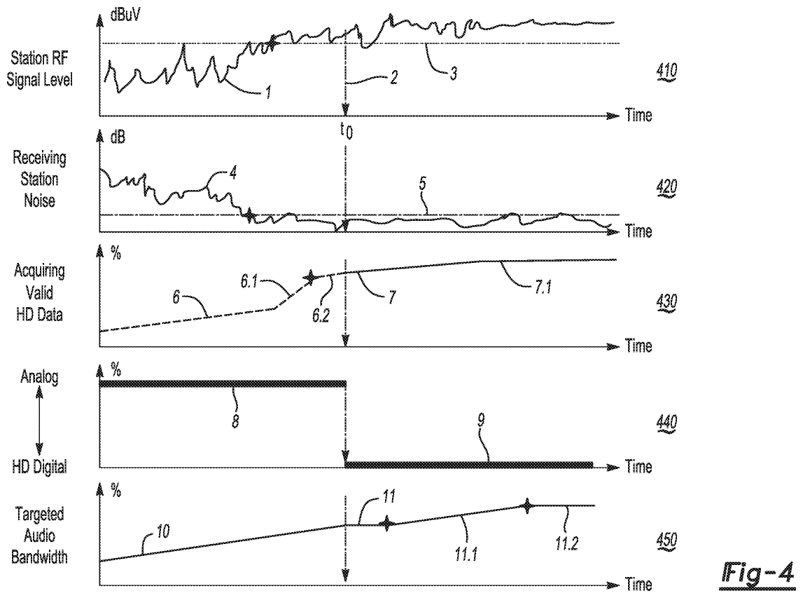

FIG. 4 illustrates signal changes over time during a switch from an analog path to a digital path, according to one or more embodiments. Each of the lines have a common time axis. As shown in first line 410, a station radio frequency (RF) signal 1 may fluctuate over time. At some point, the station RF signal 1 may exceed a predetermined signal threshold 2. At time 3, the switch from analog to signal to high definition (HD) digital signal may occur.

As shown at 420, there may be receiving station noise 4. This noise may, at some point, dip below a predetermined noise threshold 5.

As shown at 430, acquisition of valid HD data 6 may occur at a variety of levels. This acquisition may be correlated to the graphs at 410 and 420. Thus, for example, when noise 4 is above the predetermined noise threshold 5 and/or the signal is below the predetermined signal threshold 2, relatively little valid HD data 6 may be acquired. However, once both thresholds 2 and 5 have been crossed, valid HD data 6.1 may be increasingly acquired. The system may continue acquiring valid HD data 6.2 even after a dramatic improvement occurred over 6.1. This may permit filling a buffer, for example. Even after the switch at time 3, the amount of valid HD data 7 may continue to improve until a practical maximum amount of valid HD data 7.1 is reached.

As shown at 440, there may be a switch at time 3 between use of the analog 8 and HD 9. The graph shows percentage of analog 8, with the use of analog 8 at 100% before time 3 and the use of analog 8 after time 3 at 0%.

As shown at 450, targeted audio bandwidth 10 may also vary with time. When the switch occurs at 3, the new targeted audio bandwidth 11 may be selected initially to match the previous targeted audio bandwidth 10. After some time, an increasing targeted audio bandwidth 11.1 may be applied until a maximum targeted audio bandwidth 11.2 is reached. This approach may provide a smooth listening experience for a user of the system.

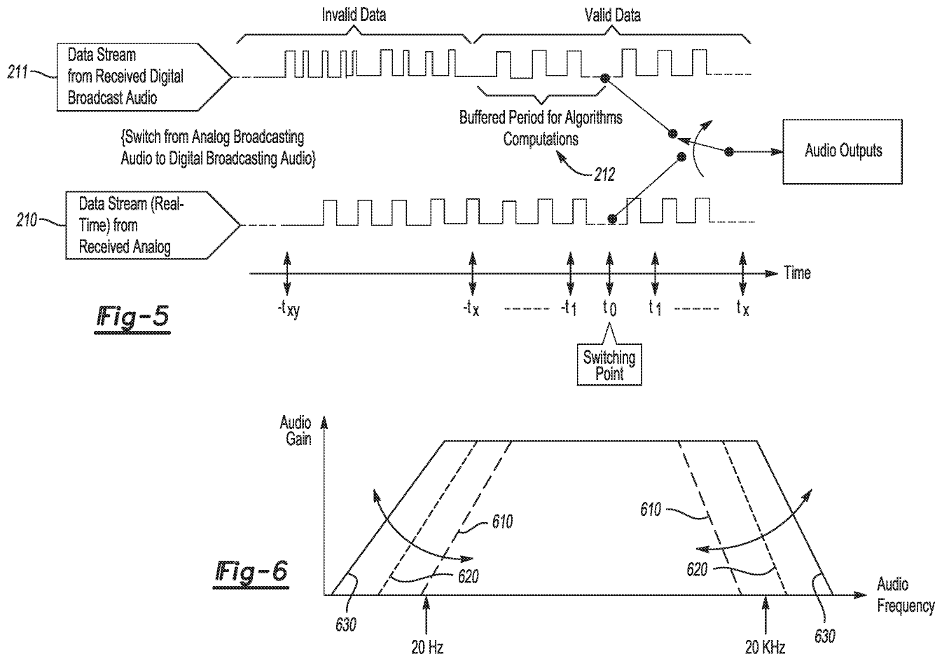

FIG. 5 illustrates switching between data streams according to one or more embodiments. As shown in FIG. 5, a digital data stream 211 may be received from digital broadcast source. Concurrently, analog data stream 210 may be received in real time from an analog broadcast source. Both data streams may provide the same audio in different formats.

As shown in FIG. 5, from time −t_{XY} to −t_{X}, there may be invalid data received via digital data stream 211. This may mean that the amount of valid data is below some threshold. At time −t_{X}, the digital data stream 211 may begin to receive valid data. There may be a buffered period 212, which may allow for computations to occur for various actions including adjusting a bandwidth of the audio to match the analog bandwidth. At t₀, the switch may occur. Times −t₁, t₁ and t_{X} are shown for context. At the switching point, a switch may provide the digital data stream 211 to audio outputs rather than providing analog data stream 210.

FIG. 6 illustrates variations on audio bandwidth, according to one or more embodiments. As shown in FIG. 6, there may be multiple audio bandwidths of a given audio stream over time. For example, there may be a narrow bandwidth 610, a medium bandwidth 620, and a high bandwidth 630. In each case, the gain may be at a maximum level for most of the range and may drop off toward either side. The drop offs are not shown to scale. The values of 20 Hz and 20 kHz are shown because these represent typical target values for audio for human listening. The high bandwidth 630 approach may provide maximum gain across the entire 20 Hz to 20 kHz spectrum, whereas the other approaches may provide insignificant gain over parts of the spectrum. In this illustration, the gain near 20 Hz for the narrow bandwidth approach is very low and is even lower at 20 kHz.

If there is a sudden change between narrow bandwidth 610 and high bandwidth 630, this may be particularly noticeable to a listener, particularly at the upper and lower ends of the register, namely near 20 kHz and 20 Hz.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

Various terms are used to refer to particular system components. In the above discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“Controller” may refer to individual circuit components, an application-specific integrated circuit (ASIC), a microcontroller with controlling software, a digital signal processor (DSP), a processor with controlling software, a field programmable gate array (FPGA), or combinations thereof.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. An audio system comprising:
a tuner configured to receive a broadcast signal; and
a controller coupled to the tuner and configured to:
condition the broadcast signal for an analog path and a digital path;
compare a reproduction characteristic of the broadcast signal from the analog path to a reproduction characteristic of the broadcast signal from the digital path; and
adjust, based on the comparison, a further reproduction characteristic of the broadcast signal from the digital path.

2. The audio system of claim 1, wherein the controller is configured to select, based on the comparison, between outputting the broadcast signal from the analog path and outputting the broadcast signal from the digital path.

3. The audio system of claim 2, wherein the controller is configured to adjust the further reproduction characteristic of the broadcast signal from the digital path to match a further reproduction characteristic of the broadcast signal from the analog path to yield a uniform sound field between the digital path and the analog path.

4. The audio system of claim 3, wherein the controller is configured to switch between outputting the broadcast signal from the analog path and outputting the broadcast signal from the digital path.

5. An audio system comprising:
a tuner configured to receive a broadcast signal; and
a controller coupled to the tuner and configured to:
condition the broadcast signal for an analog path and a digital path;
compare a reproduction characteristic of the broadcast signal from the analog path to a reproduction characteristic of the broadcast signal from the digital path; and
adjust, based on the comparison, a further reproduction characteristic of the broadcast signal from the analog path.

6. The audio system of claim 5, wherein the controller is configured to select, based on the comparison, between outputting the broadcast signal from the analog path and outputting the broadcast signal from the digital path.

7. The audio system of claim 6, wherein the controller is configured to adjust the further reproduction characteristic of the broadcast signal from the analog path to match a further reproduction characteristic of the broadcast signal from the digital path to yield a uniform sound field between the digital path and the analog path.

8. The audio system of claim 7, wherein the controller is configured to switch between outputting the broadcast signal from the analog path and outputting the broadcast signal from the digital path.

9. A non-transitory computer-readable storage medium including instructions that, when executed by a processor, cause the processor to output a sub-stream in an audio system, by performing the steps of:
receiving, at a device, a media stream via a first wireless connection in an analog format;
digitizing the media stream as received via the first wireless connection to provide a first sub-stream;
receiving, at the device, the media stream via a second wireless connection in a digital format as a second sub-stream;
comparing, at the device, at least one reproduction characteristic of the first sub-stream and the second sub-stream; and
adjusting, based on the comparison, at least one further reproduction characteristic of either the first sub-stream or the second sub-stream.

10. The non-transitory computer-readable storage medium of claim 9, wherein the first wireless connection and the second wireless connection are received over a same antenna in the device.

11. The non-transitory computer-readable storage medium of claim 9, wherein the first wireless connection and the second wireless connection are received over different antennas in the device.

12. The non-transitory computer-readable storage medium of claim 9, wherein the at least one reproduction characteristic comprises audio bandwidth.

13. The non-transitory computer-readable storage medium of claim 9, wherein the at least one further reproduction characteristic comprises audio bandwidth.

14. The non-transitory computer-readable storage medium of claim 9, further comprising:
switching an output from the first sub-stream to the second sub-stream, based on analyzing a signal characteristic of the second sub-stream.

15. The non-transitory computer-readable storage medium of claim 14, wherein the switching is based on a valid audio data rate exceeding a threshold data rate, wherein the signal characteristic comprises the valid audio data rate.

16. The non-transitory computer-readable storage medium of claim 14, wherein the switching is based on an amount of buffered audio data exceeding a threshold number of milliseconds, wherein the signal characteristic comprises the amount of buffered audio data.

17. The non-transitory computer-readable storage medium of claim 14, wherein the switching is based on a digital signal-to-noise ratio exceeding a threshold number of decibels, wherein the signal characteristic comprises the digital signal-to-noise ratio.

18. The non-transitory computer-readable storage medium of claim 9, further comprising:
increasing a digital audio bandwidth of the adjusted one of the first sub-stream or second sub-stream toward a predetermined bandwidth at a predetermined rate.

19. The non-transitory computer-readable storage medium of claim 9, further comprising:
adjusting an analog audio bandwidth of the first sub-stream to continuously track a digital audio bandwidth of the second sub-stream.

20. The non-transitory computer-readable storage medium of claim 9, further comprising:
switching from the second sub-stream to the first sub-stream based on a buffer status, wherein the buffer status comprises a buffer being empty, wherein the switching is performed after the adjusting.
